(19) United States
(12) Patent Application Publication
(10) Pub. No.: US 2007/0171441 A1
(43) Pub. Date: Jul. 26, 2007

(54) Color and darkness management system

(75) Inventor: Edward M. Granger, Novato, CA (US)

Correspondence Address: GAMBURD LAW GROUP LLC, 600 WEST JACKSON BLVD., SUITE 625, CHICAGO, IL, 60661, US

(73) Assignee: IQ Colour, LLC, Bloomfield Hills, MI (US)

(21) Appl. No.: 11/336,202

(22) Filed: Jan. 21, 2006

(51) Int. Cl. G06F 15/00

(52) U.S. Cl. 358/1.9

(57) ABSTRACT

The present invention provides a color and darkness management system, method, apparatus and software for determining colorant values for reproduction of an image on an output medium having a minimum darkness, and with the reproduction having a maximum black colorant darkness on the output medium. An exemplary apparatus embodiment comprises a memory and a processor. The processor is adapted, when an input darkness level of a selected pixel is greater than a first predetermined darkness level, to nonlinearly constrain an output black darkness of the selected pixel to a value less than or equal to the lesser of the input darkness level and the maximum darkness; when the input darkness level of the selected pixel is less than a second predetermined level, to nonlinearly constrain the output black darkness of the selected pixel to a value greater than or equal to the greater of the input darkness level and the minimum darkness; and otherwise to determine the output black darkness of the selected pixel as a substantially linear mapping from the input darkness level.

### CROSS-REFERENCE TO A RELATED APPLICATION

This application is related to and claims priority to U.S. patent application Ser. No.______, filed concurrently herewith, inventor Edward M. Granger, entitled “Color and Neutral Tone Management System”, which is commonly assigned herewith, the contents of which are incorporated herein by reference, and with priority claimed for all commonly disclosed subject matter.

### FIELD OF THE INVENTION

The present invention, in general, relates to color management systems, and more particularly, relates to color and brightness modeling and appearance transformation for perceptually accurate image and graphical rendering for graphical arts, printing, publishing, and display technologies.

### BACKGROUND OF THE INVENTION

Color rendering technologies have continued to evolve with other technologies, such as color display technologies (e.g., cathode ray tube (CRT) displays, flat panel displays), color printing technologies, scanning technologies, and publishing technologies. For example, an individual may now capture a color image through a digital camera or scanner, and using computer software such as Adobe Photoshop, may manipulate the image and print the resulting product. As the image is displayed on a computer display screen or other user interface, it has become desirable for the resulting printed image to be a perceptually accurate match of the displayed image.

Typically, each pixel of the displayed image is specified utilizing the additive primaries of red (“R”), green (“G”)and blue (“B”) (collectively referred to as “RGB”) data which, when combined in the specified combination, results in the display of the selected color, such as red and green combining to produce yellow. A standard RGB specification has been developed, referred to as “sRGB”, particularly suited for use in electronic displays, such as active matrix, LCD, CRT or plasma displays. Other RGB standard specifications are also available and utilized by those of skill in the color management and rendering arts and sciences.

Conversely, typical color printing technologies utilize a selected combination of subtractive primaries and black, typically implemented utilizing at least four inks, cyan (“C”), magenta (“M”) yellow (“Y”) and black (“K”) (collectively referred to as “CMYK”). Depending upon the printing technology, additional ink colors may also be utilized, providing systems having 6 or 8 printing colors, for example. The various overprints of CMYK combine to produce other colors, such as cyan and magenta combining to produce blue, and yellow and magenta combining to produce red.

The prior art documents numerous attempts and systems to provide accurate color rendering, typically defining a color space which may be utilized to specify a particular color, as perceived by a “standard” observer, in terms of its hue (perceived color), lightness/darkness (degree to which the perceived color is equivalent to one of a series of grays ranging from black to white), and saturation or chroma (the amount or degree of color of the same hue (or departure from a gray of the same lightness). Such color spaces are often defined using standardized tristimulus values, such as the CIE (Commission International de l'Enlarge) XYZ color space (1931), the CIELAB space, Munsell values, and so on.

The various prior art systems, however, typically result in similar difficulties and inaccuracies. For example, colors may have equally measured luminance (Y component), yet are perceived differently, particularly with blue colors being perceived as less bright than yellow colors having the same measured luminance values. Similarly, most rendering of shadow results in color being replaced by black, such that a dark blue is inaccurately rendered as a black color, resulting in a loss of color in an image reproduction.

In addition, various colors created under one set of lighting conditions often appear to be different under other lighting conditions, as a phenomenon referred to as “metamerism”. As various combinations of cyan, yellow and magenta are typically utilized to create neutral tones (e.g., grays), metamerism is often a significant concern in the prior art, with color rendering forced to be based upon the predicted lighting conditions for the consumer or observer, such as incandescent lighting used in a home, compared to fluorescent lighting in an office or to daylight from outdoors.

As a consequence, a need remains for a color management system which provides perceptually accurate image reproduction, such that an image produced by a color printer is perceived as an accurate reproduction of the same image displayed on a computer screen, or that an image displayed on a computer screen is perceived as an accurate reproduction of the same scanned image or photographed image, for example. Such a color management system should further provide for such perceptually accurate rendering across a wide variety of printing media and display systems, without requiring corresponding changes to the original image. Such a system should reduce metameric effects and reduce the amounts of colored inks utilized in image reproduction, to provide a substantially better image quality and to result in a substantial savings in ink usage.

### SUMMARY OF THE INVENTION

The exemplary embodiments of the present invention provide a new color management system for image reproduction, rendering and reproducing images to appear perceptually accurate, rather than merely colorimetrically accurate. For example, the exemplary embodiments provide that an image reproduced by a color printer will perceived as an accurate reproduction of the same image displayed on a computer screen, or that an image displayed on a computer screen is perceived as an accurate reproduction of the same scanned image or photographed image, even though the reproductions may be constrained by other factors, such as a minimum paper or substrate darkness, or a limited color gamut for the reproduction. The exemplary embodiments of the inventive color, darkness and neutral tone management system further provides for such perceptually accurate rendering across a wide variety of printing media and display systems, without requiring corresponding changes to the original image, using a concept of a “meta printer”. The exemplary embodiments reduce metameric effects and reduce the amounts of colored inks utilized in image reproduction, to provide a substantially better image quality and to result in a substantial savings in ink usage.

In a first exemplary embodiment, a processor-implemented method of determining colorant values for reproduction of an image is provided. The exemplary method comprises: providing as input a first plurality of tristimulus values for a selected pixel of the image; determining an output hue for the selected pixel; determining an output saturation for the selected pixel; determining an output darkness for the selected pixel, wherein the output darkness is constrained nonlinearly by a minimum darkness of a substrate and a maximum darkness of selected colorants applied to the substrate; and determining a corresponding plurality of colorant values for the output hue, output saturation and output darkness of the selected pixel.

The output saturation for the selected pixel may be constrained below a corresponding chromaticity gain limit, which may be determined as a maximum perceived chromaticity as a function of increasing colorant saturation.

The plurality of tristimulus values are at least one of the following types of tristimulus values: CIE XYZ, CIELAB, RGB, ATD, or Qtd, as explained below. The plurality of tristimulus values are determined as an input of a corresponding plurality of digital values from a scanned image, from a digital photograph, or from a digital graphics image.

The determination of the output darkness for the selected pixel further comprises: (1) when an input darkness of the selected pixel is greater than a first predetermined darkness level, constraining an output black darkness of the selected pixel to a value less than or equal to the lesser of the input darkness and the maximum darkness, generally through a nonlinear mapping; (2) when the input darkness of the selected pixel is less than a second predetermined darkness level, constraining an output black darkness of the selected pixel to a value greater than or equal to the greater of the input darkness and the minimum darkness, also generally through a nonlinear mapping; and (3) when the input darkness of the selected pixel is not greater than the first predetermined darkness level and is not less than the second predetermined darkness level, determining the output black darkness of the selected pixel as substantially equal to the input darkness.

A neutral model is also incorporated in determining the darkness for the selected pixel, including: (1) selecting a darkness level provided as a black colorant having a saturation between about zero and one hundred percent and with a primary colorant providing less than about seven to ten percent saturation; (2) selecting a darkness level provided as a black colorant having a saturation between about zero and one hundred percent and with a primary colorant providing less than about forty to one-hundred percent saturation; and/or (3) selecting a darkness level provided as a black colorant and not more than two primary colorants. In addition, the determination of the corresponding plurality colorant values for the determined hue, saturation and darkness of the selected pixel may also include substantially maintaining a chroma for the determined hue and saturation until the determined darkness is greater than about eighty percent.

For system embodiments, the determination of the hue, the saturation and the darkness for the selected pixel may further comprise: (1) performing at least one database table lookup indexed by the plurality of tristimulus values; determining the corresponding plurality of colorant values by performing at least one database table lookup, the database table containing a corresponding plurality of primary and black colorant values calibrated for a selected output device.

In exemplary embodiments, the plurality of tristimulus values further comprises at least one brightness value which is substantially nonlinear with respect to a luminance value. The plurality of tristimulus values may also further comprise a first value which is substantially a luminance value, a second value which is substantially a red and green opponent value, and a third value which is substantially a blue and yellow opponent value. In another exemplary embodiment, a plurality of tristimulus values are independent of any selected output device, and the plurality of tristimulus values encompass substantially all visually perceptible colors.

In another exemplary embodiment, a computer-implemented method is provided for determining an output darkness level for a plurality of colorant values for reproduction of an image on an output medium having a minimum darkness, the reproduction having a maximum black colorant darkness on the output medium, in which the image has a plurality of pixels. The exemplary method comprises, first, when an input darkness of a selected pixel of the plurality of pixels is greater than a first predetermined darkness level, constraining an output black darkness of the selected pixel to a value less than or equal to the lesser of the input darkness and the maximum darkness; and second, when the input darkness of the selected pixel is less than a second predetermined level, constraining the output black darkness of the selected pixel to a value greater than or equal to the greater of the input darkness and the minimum darkness. Third, when the input darkness of the selected pixel is not greater than the first predetermined darkness level and is not less than the second predetermined darkness level, determining the output black darkness of the selected pixel as a substantially linear mapping from the input darkness.

In another exemplary embodiment, an apparatus is provided for determining an output darkness level for a plurality of colorant values for reproduction of an image on an output medium having a minimum darkness, the reproduction having a maximum black colorant darkness on the output medium, with the image having a plurality of pixels. The exemplary apparatus comprises a memory and a processor coupled to the memory. The processor is adapted, when an input darkness level of a selected pixel of the plurality of pixels is greater than a first predetermined darkness level, to nonlinearly constrain an output black darkness of the selected pixel to a value less than or equal to the lesser of the input darkness level and the maximum darkness, and when the input darkness level of the selected pixel is less than a second predetermined level, to nonlinearly constrain the output black darkness of the selected pixel to a value greater than or equal to the greater of the input darkness level and the minimum darkness. The processor is further adapted, when the input darkness level of the selected pixel of the plurality of pixels is not greater than the first predetermined darkness level and is not less than the second predetermined level, to determine the output black darkness of the selected pixel as a substantially linear mapping from the input darkness level.

The processor is further adapted to substantially maintain a chroma for the selected pixel until the output black darkness is greater than about eighty percent. The processor is further adapted, when the selected pixel is out-of-gamut for a selected output device, to map the selected pixel to one or more output values having substantially the same chroma and same proportional brightness of the selected pixel. The processor is further adapted to constrain an output saturation of the selected pixel below a corresponding chromaticity gain limit.

The processor is further adapted to provide an output neutral tone as a substantially linearly increasing black colorant up to about eighty percent saturation coupled with a primary colorant constrained to less than about ten percent saturation, and to provide an output neutral tone as a black colorant having 80-100 percent saturation coupled with a primary colorant constrained to less than about eighty percent saturation.

The image may be provided as a plurality of tristimulus values which are independent of any selected output device. In exemplary embodiments, the memory is adapted to store a database table, and the processor is further adapted to determine a hue, a saturation and the darkness for the selected pixel by performing at least one database table lookup indexed by a plurality of tristimulus values. The database table is adapted to store a corresponding plurality of primary and black colorant values calibrated for a selected output device.

In another exemplary embodiment, a machine-readable medium is provided for storing instructions for determining an output darkness level for a plurality of colorant values for reproduction of an image on an output medium having a minimum darkness, the reproduction having a maximum black colorant darkness on the output medium, with the image having a plurality of pixels. The machine-readable medium comprises: a first program construct to nonlinearly constrain an output black darkness of the selected pixel to a value less than or equal to the lesser of the input darkness level and the maximum darkness when an input darkness level of a selected pixel of the plurality of pixels is greater than a first predetermined darkness level; and a second program construct to nonlinearly constrain the output black darkness of the selected pixel to a value greater than or equal to the greater of the input darkness level and the minimum darkness when the input darkness level of the selected pixel is less than a second predetermined level.

The machine-readable medium may further comprise: a third program construct to determine the output black darkness of the selected pixel as a substantially linear mapping from the input darkness level when the input darkness level of the selected pixel of the plurality of pixels is not greater than the first predetermined darkness level and is not less than the second predetermined level; a fourth program construct to substantially maintain a chroma for the selected pixel until the output black darkness is greater than about eighty percent; a fifth program construct to map the selected pixel to one or more output values having substantially the same chroma and same proportional brightness of the selected pixel when the selected pixel is out-of-gamut for a selected output device; a sixth program construct to constrain an output saturation of the selected pixel below a corresponding chromaticity gain limit; a seventh program construct to provide an output neutral tone as a substantially linearly increasing black colorant up to about eighty percent saturation coupled with a primary colorant constrained to less than about ten percent saturation; and an eighth program construct to determine a hue, a saturation and the darkness for the selected pixel by performing at least one database table lookup indexed by a plurality of tristimulus values.

In another exemplary embodiment, a computer-implemented method provides a plurality of neutral color values for reproduction of an image on an output medium, with a black colorant applied to the output medium having a maximum black colorant darkness. The method comprises: providing a black colorant in substantially linear increments to the maximum black colorant darkness to provide a plurality of black increments; providing a first plurality of primary colorants at about a first colorant level; and combining the first plurality of primary colorants with each black increment of the plurality of black increments to form a first plurality of neutral increment values. The first colorant level is typically between about 6 to 7 percent saturation.

The exemplary method may further comprise: providing a second plurality of primary colorants at about a second colorant level, the second colorant level comparatively lower than the first colorant level; and combining the second plurality of primary colorants with each black increment of the plurality of black increments to form a second plurality of neutral increment values. The second colorant level is typically between about 5 to 6 percent saturation. The exemplary method may further comprise: providing a third plurality of primary colorants at about a third colorant level, the third colorant level comparatively greater than the first colorant level; and combining the third plurality of primary colorants with each black increment of the plurality of black increments to form a third plurality of neutral increment values. The third colorant level is typically between about 7 to 8 percent saturation.

The exemplary method may further comprise: providing a fourth plurality of primary colorants in substantially quadratic increments at about a fourth colorant level to provide a plurality of primary colorant increments, the fourth colorant level comparatively greater than the first colorant level and the third colorant level; and combining the fourth plurality of primary colorants with a subset of the plurality of black increments, the subset of the plurality of black increments having corresponding black colorant levels greater than a first predetermined threshold, to form a fourth plurality of neutral increments. The fourth colorant level is typically between about 40 to 100 percent saturation, and the predetermined threshold is typically about eighty percent input darkness. The exemplary method may further comprise: providing a fifth plurality of primary colorants about at or below a fifth colorant level, the fifth colorant level comparatively lower than the second colorant level; and combining the fifth plurality of primary colorants with each black increment of the plurality of black increments to form a fifth plurality of neutral increment values. The fifth colorant level is typically between about zero to 5 percent saturation. The exemplary method may further comprise combining the first, second, third, fourth and fifth pluralities of neutral increment values to form the plurality of neutral color values.

In another exemplary embodiment, an apparatus provides a plurality of neutral color values for reproduction of an image on an output medium, with a black colorant applied to the output medium having a maximum black colorant darkness. The apparatus comprises a memory and a processor coupled to the memory. The memory is adapted to store a database, the database indexed by a plurality of tristimulus values, the database having a first plurality of neutral color values comprised of a black colorant in substantially linear increments in conjunction with a first plurality of primary colorants at about a first colorant level, the database further having a second plurality of neutral color values comprised of the black colorant in substantially linear increments in conjunction with a second plurality of primary colorants in increments greater than a second colorant level, the second colorant level greater than the first colorant level; and a processor coupled to the memory, the processor adapted to access the database in the memory using the plurality of tristimulus values and provide a corresponding neutral color value from the first or second plurality of neutral color values.

In this exemplary embodiment, the first colorant level is between about 5 to 8 percent saturation, and the second colorant level is about 40 percent saturation. The increments of the black colorant of the second plurality of neutral color values are typically above a predetermined threshold, such as about eighty percent input darkness. In this exemplary embodiment, the increments of the second plurality of primary colorants may be substantially quadratic. In this exemplary embodiment, the database further may have a third plurality of neutral color values comprised of the black colorant in substantially linear increments in conjunction with a third plurality of primary colorants in substantially linear increments less than the first colorant level, such as for less than about 5 to 8 percent input darkness.

In addition, in this exemplary embodiment, the first and second pluralities of primary colorants are comprised of fewer than three primary colorants.

In another exemplary embodiment, a machine-readable medium is provided for storing instructions for providing a plurality of neutral color values for reproduction of an image on an output medium, with a black colorant applied to the output medium having a maximum black colorant darkness. The machine-readable medium comprises: a first program construct to provide a first plurality of neutral color values comprised of a black colorant in substantially linear increments in conjunction with a first plurality of primary colorants at about a first colorant level; a second program construct to provide a second plurality of neutral color values comprised of the black colorant in substantially linear increments in conjunction with a second plurality of primary colorants in quadratic increments greater than a second colorant level, the second colorant level substantially greater than the first colorant level; and a third program construct to provide a third plurality of neutral color values comprised of the black colorant in substantially linear increments in conjunction with a third plurality of primary colorants in substantially linear increments less than the first colorant level.

These and additional embodiments are discussed in greater detail below. Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings and examples which form a portion of the specification, wherein like reference numerals are used to identify identical or similar components in the various views, in which:

Figure (or “FIG.”) 1 is a block diagram illustrating exemplary color management system and apparatus embodiments in accordance with the teachings of the present invention.

Figure (or “FIG.”) 2 is graphical diagram illustrating an exemplary ATD color space in accordance with the teachings of the present invention.

Figure (or “FIG.”) 3 is graphical diagram illustrating a comparison of an exemplary ATD color space to a Munsell color space and to a CIE XYZ color space.

Figure (or “FIG.”) 4 is graphical diagram illustrating exemplary vectors within a “td” chromaticity coordinate system in accordance with the teachings of the present invention.

Figure (or “FIG.”) 5 is graphical diagram illustrating an exemplary chromaticity gain limit in accordance with the teachings of the present invention.

Figure (or “FIG.”) 6 is graphical diagram illustrating an exemplary saturation (chromaticity gain) compander in accordance with the teachings of the present invention.

Figure (or “FIG.”) 7 is diagram illustrating an exemplary overprint chromaticity gain limit in accordance with the teachings of the present invention.

Figure (or “FIG.”) 8 is an exemplary 100 step chart for color management system linearization in accordance with the teachings of the present invention.

Figure (or “FIG.”) 9 is graphical diagram illustrating an exemplary chroma reduction and convergence to black chromaticity point in accordance with the teachings of the present invention.

Figure (or “FIG.”) 10 is graphical diagram illustrating an exemplary darkness and brightness model in accordance with the teachings of the present invention.

Figure (or “FIG.”) 11 is graphical diagram illustrating an exemplary darkness output for black and neutral models in accordance with the teachings of the present invention.

Figure (or “FIG.”) 12 is diagram illustrating an exemplary neutral model in accordance with the teachings of the present invention.

Figure (or “FIG.”) 13 is graphical diagram illustrating an exemplary chroma reduction for a darkness model in accordance with the teachings of the present invention.

Figure (or “FIG.”) 14 is diagram illustrating exemplary proportional out-of-gamut companding in accordance with the teachings of the present invention.

Figure (or “FIG.”) 15 is a hex chart for color management system calibration in accordance with the teachings of the present invention.

Figure (or “FIG.”) 16, divided into FIGS. 16A and 16B, is a flow chart for determining colorant values for the color management methodology in accordance with the teachings of the present invention, and may be embodied as software, for example.

### DETAILED DESCRIPTION OF THE EXEMPLARY EMBODIMENTS

While the present invention is susceptible of embodiment in many different forms, there are shown in the drawings and will be described herein in detail specific examples and embodiments thereof, with the understanding that the present disclosure is to be considered as an exemplification of the principles of the invention and is not intended to limit the invention to the specific examples and embodiments illustrated.

The present invention is modeled upon how an artist may utilize his or her palette of colors, rather than modeled upon traditional color separation techniques utilizing red, green, and blue filters to produce separations into cyan, magenta, and yellow, respectively. Instead, the present invention focuses on developing the selected hue and saturation of the brightest available colors, which are then proportionally darkened, such as by shadow. The present invention utilizes various chromaticity gain, darkness/brightness and neutral modeling to provide an “appearance” transform to produce a perceptually accurate image reproduction, rather than a calorimetrically accurate reproduction. In addition, to further maintain image appearance, the exemplary embodiments utilize a proportional companding or compression of out-of-gamut brightness levels, to preserve comparative proportions in resulting reproductions.

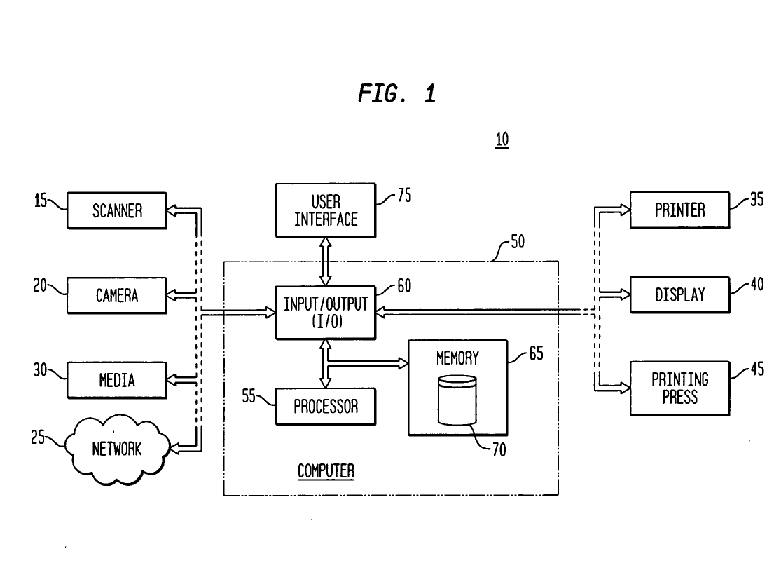

FIG. 1 is a block diagram illustrating exemplary color management system 10 and apparatus 50 embodiments in accordance with the teachings of the present invention. As illustrated, the apparatus 50 may be embodied as a computer, a server, or any other type of processing or controlling device, such as a printing system controller utilized in the graphic arts and printing fields. Image or data input for the system 10 may be provided through any of a plurality of input devices, such as a color scanner 15 or color (digital) camera 20, or may be provided in the form of electronic data (e.g., electronic files), through a network 25 (such as the Internet, a cable network, or the public switched telephone network, for example) or computer (machine) readable media 30, such as a floppy disk, a CD-ROM, a memory card, etc.

In addition, input images may be generated through a user interface 75 coupled to or forming part of the apparatus 50, such as though a keyboard, computer mouse, pointing device, which may include a display (e.g., 40) for visual presentation of the image. For example, an individual may utilize the user interface and apparatus 50 to create a graphics image or other artwork, using any available graphics or photography software.

Similarly, image or data output from the color management system 10 may be provided to any of a plurality of output devices such as a printer 35 (e.g., a laser or inkjet printer), an electronic display 40, such as a CRT, plasma or LCD display, or a printing press 45, for example. In addition, output may also be provided in the form of electronic data through network 25 or machine-readable media 30, such as to transmit to another location or a remote location, (e.g., from an office to a printing plant or facility).

As illustrated in FIG. 1, the apparatus 50 comprises a processor 55, an input and output (“I/O”) interface (or other I/O means) 60, and a memory 65 (which may further comprise the data repository 70). In the apparatus 50, the interface 60 may be implemented as known or may become known in the art, to provide data communication between, first, the processor 55, memory 65 and/or data repository 70, and second, any of the various input and output devices, mechanisms and media discussed herein, including wireless, optical or wireline, using any applicable standard, technology, or media, without limitation. In addition, the I/O interface 60 may provide an interface to any CD or disk drives, or an interface to a communication channel for communication via network 25, or an interface for a universal serial bus (USB), for example. In other embodiments, the interface 60 may simply be a bus (such as a PCI or PCI Express bus) to provide communication with any form of media or communication device, such as providing an Ethernet port, for example. Also for example, the I/O interface 60 may provide all signaling and physical interface functions, such as impedance matching, data input and data output between external communication lines or channels (e.g., Ethernet, Ti or ISDN lines) coupled to a network 25, and internal server or computer communication busses (e.g., one of the various PCI or USB busses), for example and without limitation. In addition, depending upon the selected embodiment, the I/O interface 60 (or the processor 55) may also be utilized to provide data link layer and media access control functionality.

The memory 65, which may include a data repository (or database) 70, may be embodied in any number of forms, including within any computer or other machine-readable data storage medium, memory device or other storage or communication device for storage or communication of information such as computer-readable instructions, data structures, program modules or other data, currently known or which becomes available in the future, including, but not limited to, a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, a memory integrated circuit (“IC”), or memory portion of an integrated circuit (such as the resident memory within a processor IC), whether volatile or non-volatile, whether removable or non-removable, including without limitation RAM, FLASH, DRAM, SDRAM, SRAM, MRAM, FeRAM, ROM, EPROM or E²PROM, or any other type of memory, storage medium, or data storage apparatus or circuit, which is known or which becomes known, depending upon the selected embodiment. In addition, such computer readable media includes any form of communication media which embodies computer readable instructions, data structures, program modules or other data in a data signal or modulated signal, such as an electromagnetic or optical carrier wave or other transport mechanism, including any information delivery media, which may encode data or other information in a signal, wired or wirelessly, including electromagnetic, optical, acoustic, RF or infrared signals, and so on. The memory 65 is adapted to store various programs or instructions (of the software of the present invention) and database tables, discussed below.

The apparatus 50 further includes one or more processors 55, adapted to perform the functionality discussed below. As the term processor is used herein, a processor 55 may include use of a single integrated circuit (“IC”), or may include use of a plurality of integrated circuits or other components connected, arranged or grouped together, such as microprocessors, digital signal processors (“DSPs”), parallel processors, multiple core processors, custom ICs, application specific integrated circuits (“ASICs”), field programmable gate arrays (“FPGAs”), adaptive computing ICs, associated memory (such as RAM, DRAM and ROM), and other ICs and components. As a consequence, as used herein, the term processor should be understood to equivalently mean and include a single IC, or arrangement of custom ICs, ASICs, processors, microprocessors, controllers, FPGAs, adaptive computing ICs, or some other grouping of integrated circuits which perform the functions discussed below, with associated memory, such as microprocessor memory or additional RAM, DRAM, SDRAM, SRAM, MRAM, ROM, FLASH, EPROM or E²PROM. A processor (such as processor 55), with its associated memory, may be adapted or configured (via programming, FPGA interconnection, or hard-wiring) to perform the methodology of the invention, as discussed below. For example, the methodology may be programmed and stored, in a processor 55 with its associated memory (and/or memory 65) and other equivalent components, as a set of program instructions or other code (or equivalent configuration or other program) for subsequent execution when the processor is operative (i.e., powered on and functioning). Equivalently, when the processor 55 may implemented in whole or part as FPGAs, custom ICs and/or ASICs, the FPGAs, custom ICs or ASICs also may be designed, configured and/or hard-wired to implement the methodology of the invention. For example, the processor 55 may implemented as an arrangement of microprocessors, DSPs and/or ASICs, collectively referred to as a “processor”, which are respectively programmed, designed, adapted or configured to implement the methodology of the invention, in conjunction with one or more databases (70) or memory 65.

As indicated above, the processor 55 is programmed, using software and data structures of the invention, for example, to perform the methodology of the present invention. As a consequence, the system and method of the present invention may be embodied as software which provides such programming or other instructions, such as a set of instructions and/or metadata embodied within a computer readable medium, discussed above. In addition, metadata may also be utilized to define the various data structures of database 70, such as to store the various color management models and calibrations discussed below.

More generally, the system, methods, apparatus and programs of the present invention may be embodied in any number of forms, such as within any type of apparatus (computer or server) 50, within a processor 55, within a computer network, within an adaptive computing device, or within any other form of computing or other system used to create or contain source code, including the various processors and computer readable media mentioned above. Such source code further may be compiled into some form of instructions or object code (including assembly language instructions or configuration information). The software, source code or metadata of the present invention may be embodied as any type of source code, such as C, C++, Java, Brew, SQL and its variations (e.g., SQL 99 or proprietary versions of SQL), DB2, XML, Oracle, or any other type of programming language which performs the functionality discussed herein, including various hardware definition languages (e.g., Verilog, HDL) when embodied as an ASIC. As a consequence, a “construct”, “program construct”, “software construct” or “software”, as used equivalently herein, means and refers to any programming language, of any kind, with any syntax or signatures, which provides or can be interpreted to provide the associated functionality or methodology specified (when instantiated or loaded into a processor or computer and executed, including the apparatus 50 or processor 55, for example). For example, various versions of the software may be embodied as discrete look up tables and mathematical calculations, implemented utilizing programs such as Excel®.

The software, metadata, or other source code of the present invention and any resulting bit file (object code or configuration bit sequence) may be embodied within any tangible storage medium, such as any of the computer or other machine-readable data storage media, as computer-readable instructions, data structures, program modules or other data, such as discussed above with respect to the memory 65, e.g., a floppy disk, a CDROM, a CD-RW, a DVD, a magnetic hard drive, an optical drive, or any other type of data storage apparatus or medium, as mentioned above.

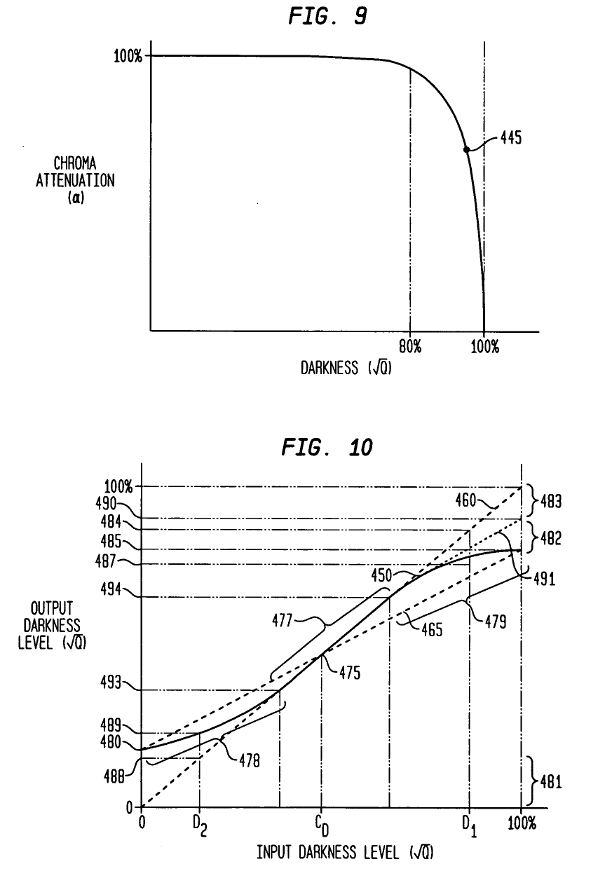

As discussed in greater detail below, the various models of the present invention, such as a chromaticity gain model, a combined darkness and brightness model, and a neutral value model, may be provided as digital values maintained in a relational database table, such as in the database 70. More specifically, for greater computational speed and efficiency, particularly when any selected image may include hundreds of millions of pixels, lookup database tables are maintained to provide output colorant values (such as CMYK, RGB, or other inking or printing system values), which have been calibrated for a selected output device, and which values have been modified in advance according to the models of the present invention. For example, for the darkness and brightness nonlinear companding of the present invention, discussed below with reference to FIGS. 9-11, every input darkness value is mapped (and companded) to a corresponding output darkness value, with the output value stored in advance in the table, rather than calculated in real time. In addition, the tables are indexed (or accessed) according to corresponding tristimulus values, which may be any of the various types of tristimulus values discussed below, in addition to the exemplary ATD or Qtd values. As a consequence, input tristimulus values for a selected pixel are utilized to perform a rapid database table lookup, which then provides the corresponding output colorant and darkness values to drive, for example, a selected color printer or printing press, thereby minimizing computational time during image reproduction.

In addition, while the present invention is frequently illustrated with respect to CMYK and RGB colorant systems, it should be understood that any colorant, printing and/or inking system is within the scope of the present invention. For example, the present invention may be utilized with any of the six or eight colorant systems typically utilized in the printing and publishing industries, which typically include a selection of both primary and secondary colorants, such as hexachrome, CMYOGK, etc. In addition, colorant systems may also include more complex systems, in which both light and dark versions of colorants are utilized.

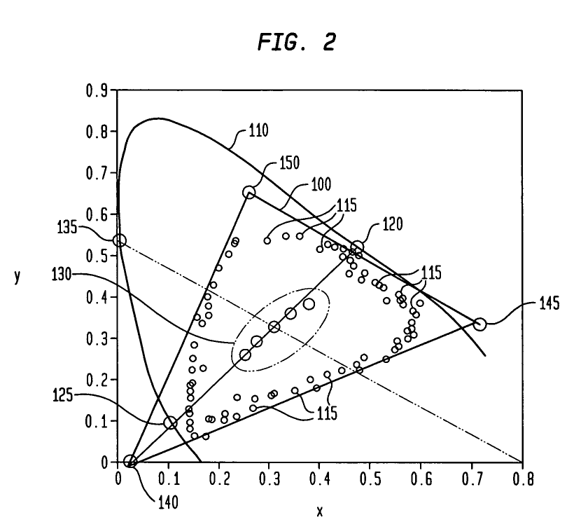

FIG. 2 is graphical diagram illustrating an exemplary ATD color space in accordance with the teachings of the present invention. The present invention utilizes an exemplary color coordinate system based on perceived brightness, referred to as “Qtd”, as a transform of an exemplary new color space referred to as “ATD”, as defined below. Importantly, such Qtd transform and ATD color space may be determined directly from a 3×3 matrix transformation from standard color spaces such as CIE XYZ (1931), “meta” RGB, as illustrated below, and using these transforms, may then be derived further from other standard color definitions, such as CIELAB or CIE Luv. As a consequence, while the invention is described with reference to ATD and Qtd, it will be understood by those of skill in the art that the invention is not limited to any specific color space or chromaticity coordinate system, and all such systems are within the scope of the present invention.

The ATD color space is defined to have three tristimulus values, a luminance component (“A”) and 2 biometrically orthogonal, opponent color difference components, with “T” being a red-green opponent component and “D” being a weighted yellow-blue opponent component. More specifically, the ATD color space may be defined in terms of a RGB color space(s), such as a “meta” RGB color space, as follows (Equation 1):

$$[ \begin{matrix}A \\ T \\ D\end{matrix} ] = [ \begin{matrix}1 & 3 & 0 \\ 1 & - 1 & 0 \\ 1 / 2 & 1 / 2 & - 1\end{matrix} ] [ \begin{matrix}R \\ G \\ B\end{matrix} ] ,$$

resulting in the tristimulus ATD values of A=R+3G, T=R−G, and D=(R+G)/2−B. Other RGB color spaces may be utilized similarly, such as sRGB.

Similarly, the ATD color space may be defined in terms of the standard CIE XYZ color space (1931), as follows (Equation 2):

$$[ \begin{matrix}A \\ T \\ D\end{matrix} ] = [ \begin{matrix}0.0 & 4.0 & 0.0 \\ 2.506 & - 2.306 & - 0.0688 \\ 0.4427 & 0.5988 & - 0.9369\end{matrix} ] [ \begin{matrix}X \\ Y \\ Z\end{matrix} ] .$$

As a consequence, the luminance component “A” is a weighted (4×) version of the CIE luminance component “Y”, while the T and D components are weighted values of all three CIE XYZ tristimulus values.

The resulting color gamut is illustrated in FIG. 2, which illustrates an exemplary ATD color space using the CIE xy chromaticity coordinates, in accordance with the teachings of the present invention. As illustrated, the ATD color space (within illustrated triangle 100 defined by the red, green and blue primaries) lies within the CIE horseshoe-shaped spectrum locus 110. The ATD color space has a unique yellow 120, a unique blue 125, daylight illuminants 130 (e.g., D65) lying on the yellow-blue axis, a unique green 135, a blue primary 140, a red primary 145, a green primary 150. The ATD color space encloses all “real world” colors, illustrated by their outer boundary of colors 115, such as all available colors of Kodak Extachrome®.

Colorants to be utilized in image reproduction may also be measured, preferably in 10 nm increments, and preferably having UV light excluded to eliminate extraneous fluorescence. Substrates such as paper may be similarly measured. The final spectral reflectance of such color samples, for each wavelength increment, is the colorant reflectance divided by the paper reflectance. The ATD tristimulus values are then derived by assuming the normalized reflectance is illuminated by a D65 light source.

This central use of D65 illuminants in defining ATD is quite helpful, as whites under D65 lighting conditions also appear white when viewed under other lighting conditions, such as typical tungsten lighting utilized in homes. As an observer adapts their perception of white to be that of D65 conditions, the colors of the image itself are also perceived as if under D65 illumination as well.

The ATD color space may then be transformed into a perceptual color space, defining a brightness component “Q”, and two chromaticity coordinates “t” and “d”. More specifically, the brightness component “Q” is importantly and significantly defined to be non-linear with respect to luminosity (“A” or “Y”), to account for the differences in perceived brightness for colors having the same measured luminosity. As a consequence, the brightness component “Q” is defined as Q=A+T/2=D, with chromaticity coordinates “t” and “d” defined relative to “Q”, as t=T/Q and d=D/Q.

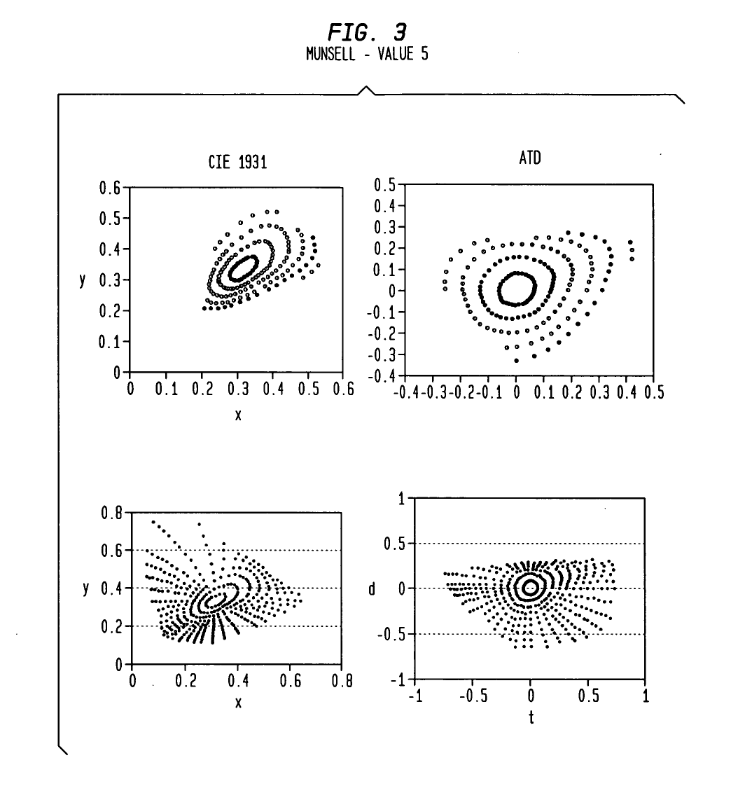

As indicated above, while the present invention is not limited to the ATD color space or the Qtd perceptual color space coordinates, there are particular advantages to use of these tristimulus values and resulting Qtd perceptual color space coordinates. Importantly, the ATD color space provides a compactness (i.e., a compact algebraic support), tightly enclosing all real world colors; as a consequence, digital representations having a limited number of bits (e.g., 8 bits (one byte)) can represent more colors, providing more fine-grained and thereby more accurate color designations, as bits are not wasted on non-reproducible or non-existent colors (i.e., those tristimulus values within CIE XYZ or other color spaces which are outside the observable color range and do not represent actual or humanly-perceptible colors). Also very significant, the ATD color space provides for a more evenly distributed color space, with differences in color being able to be represented in approximately more equal increments, as illustrated in FIG. 3, which provides a comparison of an exemplary ATD color space to a Munsell color space and to a CIE XYZ color space. This more equal distribution provides an additional advantage, namely, the ability to interpolate between values to provide perceptually accurate results.

Yet another advantage, defining ATD as RGB increments (illustrated above) further allows mathematical calculations to be performed without floating point arithmetic, allowing faster computation. As a given image may have a hundred million pixels, for example, this computational savings directly results in significant time savings, particularly important for consumer applications. It will be apparent to those of skill in the art that any tristimulus system may be converted equivalently into ATD values in such a way as to avoid any need for floating point arithmetic, such as through appropriate scaling.

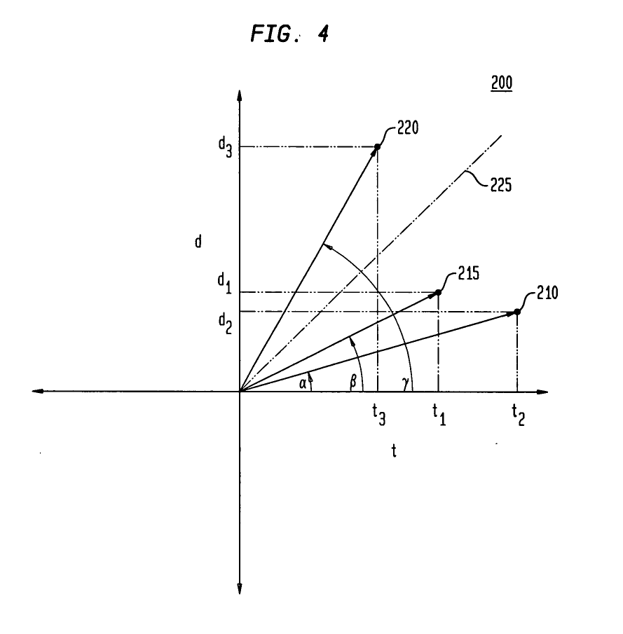

FIG. 4 is graphical diagram illustrating a plurality of exemplary vectors within a “td” chromaticity coordinate system 200 in accordance with the teachings of the present invention. Referring to FIG. 4, a first selected hue having a selected saturation level (at point 210 ) may be uniquely defined by its corresponding t and d coordinates, with the first selected hue (at point 210 ) having t₂ and d₂ coordinates. The ratio t/d defines a unique hue, with the magnitude of the distance from the origin defining the saturation level of the unique hue. It will be apparent to those of skill in the art that this use of the ratio t/d also simplifies calculations, as trigonometric calculations may be avoided. More specifically, the ratio t/d can be utilized to define a hue angle (e.g., hue angle a corresponding to t₂/d₂) corresponding to the selected hue, with the hue angle represented by its direction cosines, namely, the corresponding t₂ and d₂ values for this example. As illustrated, a second selected hue (at point 215 ) has a different hue and less saturation than the first selected hue, while a third selected hue (at point 220 ) also has a different hue and more saturation than either the first selected hue or the second selected hue. In addition, as the ratio t/d changes, it is indicative of visual attention changes; for example, as hues may transition from a point on the t-axis to a point on the d-axis (around the line 225 (where t=d)), a “tipping point” occurs, with attention being drawn more significantly to the next hue or, more specifically, to a next opponent channel mechanism, either t or d.

Regardless of how the ATD values are determined, such as by original generation or translation (transformation) from RGB or CIE XYZ, for example, the resulting ATD values will be utilized as an “index” into an exemplary color management model of the present invention. In an exemplary embodiment, the color management model of the present invention may be represented in a relational database as a series of database tables, as discussed above. The ATD values (or, equivalently, Qtd values) provide an index to such tables, which then provide corresponding output values utilized to drive or command a corresponding output device, such as a printer, a printing press, a display, or monitor. As a consequence, in sharp contrast to the prior art, the color management model of the present invention is independent of any output device. Measurements of a selected output device are utilized, however, to provide corresponding output values from the color management model such that the selected output device provides a corresponding, perceptually accurate image within the confines of the color gamut the selected output device is capable of producing.

The exemplary color management model of the present invention utilizes 256 different hues, having 192 (0 to 191) states of color saturation, and for each hue and saturation combination, 1020 levels of gray. This provides approximately 46 million states of the exemplary color management model, which is considered empirically sufficient for virtually any imaging situation. Once an input image is modeled using this rich ATD color space, this input image does not need to be changed to be output on different devices; for example, a graphical image suitable for output on a first printer does not need to be “repurposed” for output on a second printer. Rather, the ATD values for the selected input image remain static and provide the same index values into the color management model, referred to as a “meta printer”. This “meta printer” creates a model of a theoretically unlimited or ideal output device, which (through stored database values) will then be translated to calibrated values for a selected output device (which generally is not an ideal device and has typical printer limitations, such as a limited gamut) and based upon selected media (which may have brightness/darkness limitations, for example. The exemplary color management model then provides an output corresponding to the selected printer, based upon empirically determined, measured (or calibrated) values of the corresponding output device. As a consequence, once a selected output device has been calibrated, no images need to be repurposed for image reproduction on the device, with all such translation accomplished via the “meta printer”, using database tables to translate the image to the calibrated values of the output device.

The exemplary color management model of the present invention provides an “appearance transform” which utilizes and combines three separate models, namely, a linear chromaticity gain model, a (nonlinear) combined darkness and brightness model, and a neutral value model. These models are utilized to form a “translator”, from the idealized “meta printer” to any selected output device, which will translate any image (specified in ATD, RGB or XYZ, for example) to the selected output device, utilizing the color modeling and management of the present invention, to provide a perceptually accurate image reproduction. This modeling will be perceptually accurate, and may not be calorimetrically accurate. The ATD color space for the translator is populated by measuring and empirically determining values for the brightest available colors for the model. The brightest of each selected hue and saturation is referred to as “Q_{TOP}”. These values are then proportionally darkened, to create the balance of the color space. In an exemplary embodiment, the Ektachrome colors and standard lithographic colors were examined to provide such brightness values, and to create empirical formulas for converting RGB or XYZ values into the ATD color space.

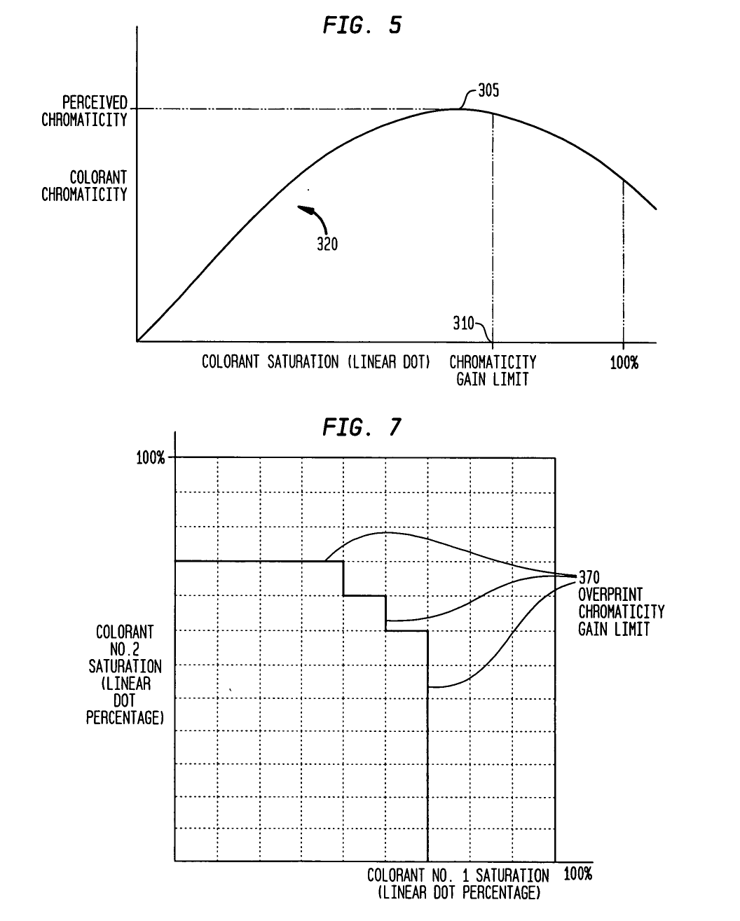

The exemplary chromaticity gain model of the present invention is illustrated in FIGS. 5-7. FIG. 5 is graphical diagram illustrating an exemplary chromaticity gain limit in accordance with the teachings of the present invention. As illustrated in FIG. 5, chromaticity initially increases with saturation (measured as a linear dot percentage), in region 320. This increase may or may not be linear; in accordance with the exemplary embodiment, such applied percentages are calibrated to achieve linear increments of chromaticity. Depending upon the ink, such as cyan or magenta, as the saturation approaches the range of 70% to 80% (in general), the perceived chromaticity will reach a maximum (305). Thereafter, increasing the amount of ink applied (as an increased percentage of linear dot) does not result in an increase in perceived chromaticity, and may even result in a decrease in perceived chromaticity, as the image may begin to grey or get darker rather than more chromatic. As a consequence, the chromaticity gain model of the present invention creates a linear chromaticity scale, and limits applied ink or pigment to the level at which the perceived chromaticity is at a maximum (and possibly slightly greater than this maximum), resulting in a chromaticity gain limit (310).

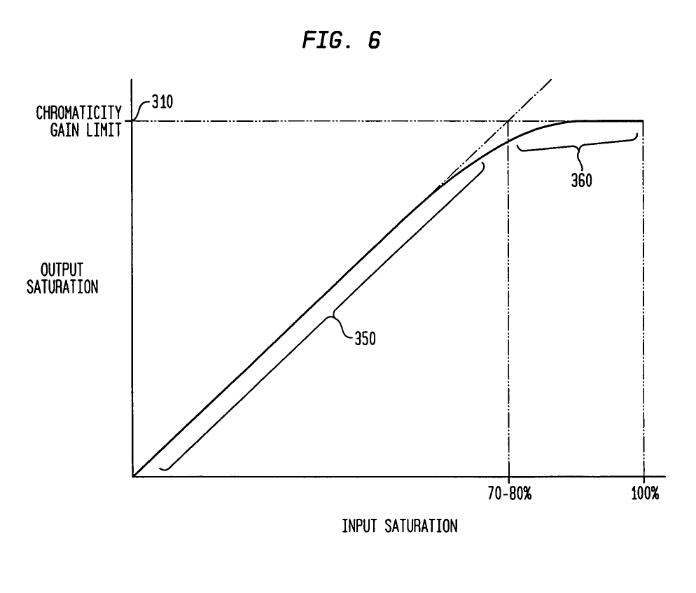

FIG. 6 is graphical diagram illustrating an exemplary saturation (chromaticity gain) compander in accordance with the teachings of the present invention, which maps input saturation (such as from an input RGB or XYZ image), to output saturation (or chromaticity), to drive an output device such as a printer. As illustrated in FIG. 6, until the vicinity of the chromaticity gain limit 310, the chromaticity gain model provide a generally linear, one-to-one mapping of input saturation to output saturation (350), typically measured as linear dot percentage. Such linearity may also require calibration of the output device, to the extent the resulting chromaticity increments are not a linear function of colorant percentages (increments). As the input saturation approaches and then exceeds the chromaticity gain limit, the chromaticity gain model will limit (or compand) the output saturation to the chromaticity gain limit (360), resulting in input values (or states) being compressed to fewer output values (or states) for higher saturation levels. As indicated above, depending upon the selected output device and inks/pigments utilized, for example, the chromaticity gain limit generally will be at approximately 70-80% linear dot. As mentioned below, this companding to a chromaticity gain limit applies to each hue, which may be a primary or secondary colorant or a hue generated as a combination of primary or secondary colorants, typically as overprints.

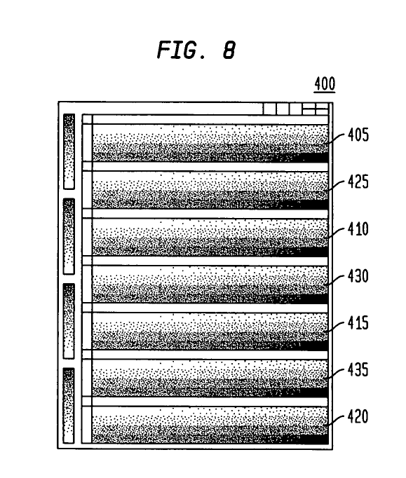

More specifically, this chromaticity gain limit is also applied to colorant combinations, which are generally applied as overprints of one primary or secondary colorant over another primary colorant. FIG. 7 is diagram illustrating an exemplary overprint chromaticity gain limit 370 in accordance with the teachings of the present invention. Input-to-output saturation companding for overprints is also utilized, as previously discussed above with reference to FIG. 6. More specifically, such companding is provided for each hue, usually as a combination of two or more primary colors, such that at higher saturation levels, more input states or values are translated to fewer output states or values, as illustrated in region 360 of FIG. 6.

In addition to significant ink savings, this chromaticity companding has the added value of moving the potential for reproduction error into imperceptible image regions. It further allows groups of output devices to be calibrated statistically, requiring less operator input and, in many instances, less required printing control, particularly for presses.

In exemplary embodiments, such companding may be digitized and stored in tables of a database, as mentioned above. For example, each hue may be mapped to a saturation index of a table, which will then provide the corresponding chromaticity level required, as calibrated for the selected output device.

FIG. 8 is an exemplary 100-step chart 400 for color management system linearization in accordance with the teachings of the present invention, typically as applied to output print devices. The chart 400 is an example and for purposes of illustration for an exemplary CMYK system and may be extended to systems having additional or different colorants; those of skill in the art will recognized that a myriad of equivalent charts are available and may be utilized equivalently.

Typically in graphic arts systems, the dot gain or tone value gain of the cyan, magenta, yellow and black inks for a CMYK system is determined as a function of the tint value provided (input) to the press, as a typical press generally prints a slightly greater tone value than the input tone value. The mid tone gain of most presses is about 15 percent. The color management system of the invention will also compensate for the output device tone gain for each color. The 100-step chart 400 allows the color management system to first linearize the output device (printer system) with respect to saturation (tone value) (i.e., linearize chromaticity as a function of applied colorant). Then, as discussed above, the color management system then provides a second step, in which the linear tone scaled data is converted to chromaticity and plotted as a function of the tone value, as illustrated in FIG. 5, to determine the chromaticity gain limits for the primary and overprint colors. At or near the peak (chromaticity gain limit), the color management system will limit the amount of ink that will be used to further calibrate the output device, such as a printer.

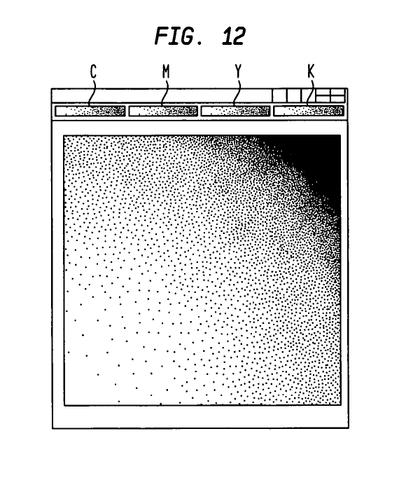

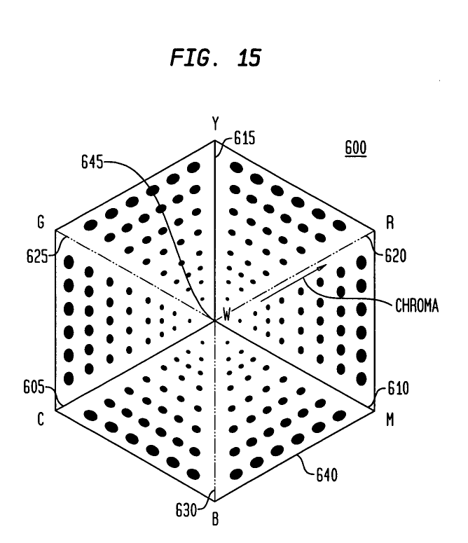

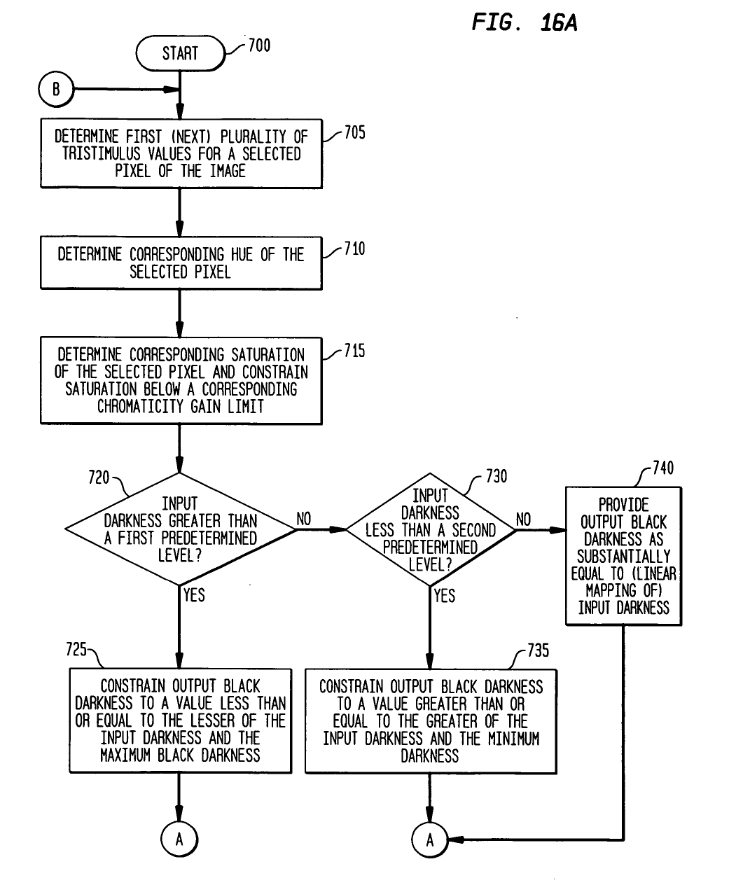

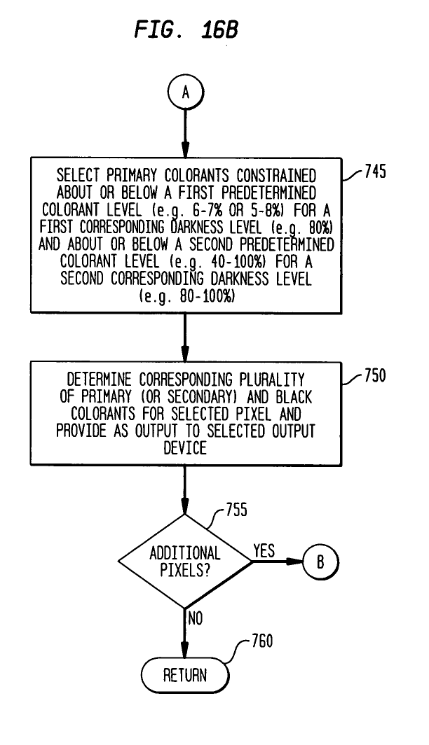

As illustrated in FIG. 8, the 100-step chart 400 is a set of long step wedges or ramps, one for each of the colors cyan (405), magenta (410), yellow (415), black (420), and the overprint colors blue (425), red (430), and green (435). The reflectance output values are then read utilizing a spectrophotometer, as known in the art, generally in 10 nm increments, and can then be utilized to calibrate the output device and to determine corresponding chromaticity gain limits for the selected output device, in addition to any shift in hue angle, and to correct for any nonlinearities in chromaticity as a function of applied colorant (dot percentages). These selected chromaticity gain limits of the selected output device may be linearly correlated with the chromaticity gain model of the color management system, such that each linear chromaticity increment of the chromaticity gain model is matched to corresponding increments of the selected output device. In addition to the 100-step chart as illustrated, a randomized version may also be produced and measured, in order to cancel out within sheet variability of measured values. Additional calibrations are discussed below with reference to FIGS. 12 and 15.

This linear chromaticity gain model, with the chromaticity gain limits determined for the selected output device, is one of several new and novel features of the present invention.

The exemplary combined darkness and brightness model of the present invention is illustrated in FIGS. 9-12. FIG. 9 is graphical diagram illustrating an exemplary chroma reduction and convergence to black chromaticity point 445 in accordance with the teachings of the present invention. As illustrated in FIG. 9, in darkening colors in accordance with the invention, chromaticity is not reduced substantially until darkness exceeds a predetermined level, illustrated as convergence to black chromaticity point 445. Also as illustrated, darkness values are measured using a brightness (Q) scale of the present invention (and not CIE Y), and may be in increments of Q or, as illustrated, in increments of the square-root of Q (Q^{1/2}), as brightness differences tend to be perceived as a function of the square-root of brightness Q. The chroma attenuation may be designated by a variable “α”, which will be utilized as an attenuation factor for the amount of C, M or Y utilized for a given pixel (discussed in greater detail below, following the discussion of FIG. 15).

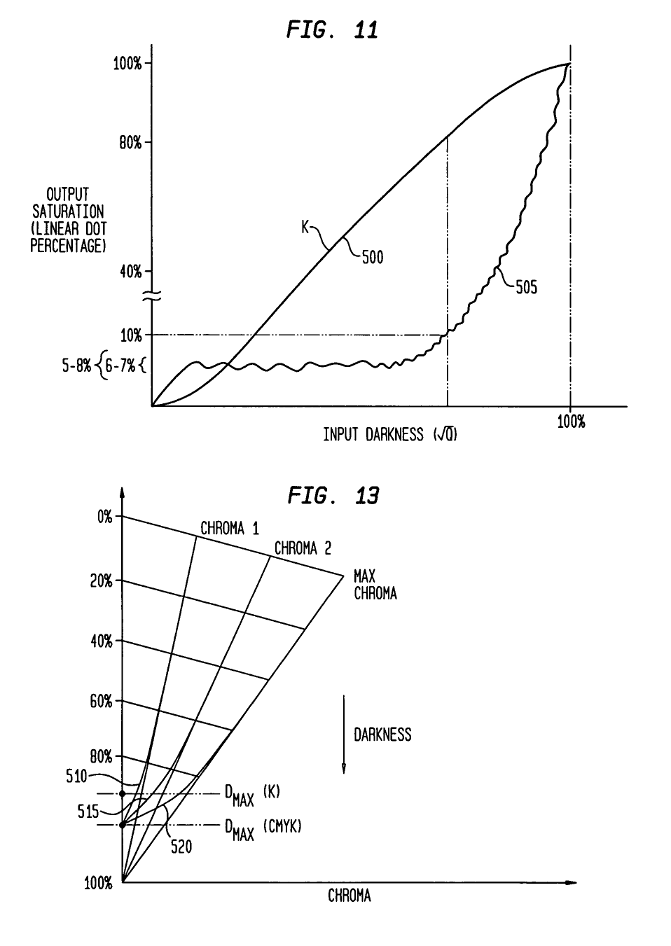

FIG. 10 is graphical diagram illustrating an exemplary darkness and brightness model (or, equivalently referred to as a darkness and saturation model) in accordance with the teachings of the present invention, and illustrates its nonlinearity. Ideally, an input darkness would be identically mapped one-to-one to an output darkness, illustrated as dashed line 460 having a slope equal to one. Various colorants, inks, displays, and so on, however, generally have a maximum darkness on a given medium or substrate, which is not as dark as an absolute blackest black. Similarly, media or substrates, such as paper used for printing, is not as bright as an absolute whitest white. For example, displays and substrates such as paper have a maximum brightness (illustrated as point 480 ), providing a minimum darkness level, with papers such as newsprint having considerable more darkness than typical white bond paper, for example. In addition, even various white bond paper substrates have different brightness levels. Similarly, maximum darkness is also limited, such as based upon selected inks and types of displays, illustrated as a maximum darkness 485 (for a black ink) and a maximum darkness 490 (for CMY combinations). In addition, as discussed in greater detail with reference to FIG. 11, black inks often have a level of transparency, limiting their ability to provide complete darkness. As a consequence, various specified darkness and lightness values will be out-of-gamut for selected output devices and/or colorant and substrate combinations, such that very light and very dark colors may not be achievable directly, illustrated as brightness out-of-gamut region 481, and darkness out-of-gamut regions 482 (black) and 483 (CMY combinations).

Another new and novel feature of the present invention allows for images to “appear” to be both lighter and darker than these maximum lightness and darkness values, using the combined darkness and brightness model of the invention. An exemplary nonlinear mapping of the combined darkness and lightness model is illustrated as the s-shaped (sigmoidal) line 450 in FIG. 10, and may be generated numerically or utilizing any of a plurality of curve-fitting algorithms (such as a 2-part curve-fitting algorithm). In addition, a plurality of sigmoidal curves are equivalently available, and any given sigmoidal curve may be selected based upon empirical results or individual preference. As illustrated, a line 465 between the minimum darkness (maximum lightness) (480) and maximum darkness (485) values will intersect the (ideal) line 460, illustrated as point 475, where the original (input darkness value) and the reproduction (output darkness value) will have the same density and apparent brightness, and the mid-tone of the original is preserved. This intersection point will vary in location depending upon the substrates (maximum brightness (minimum darkness)) and colorants/blacks utilized or otherwise available. At point 475 and its vicinity, namely, for input darkness below a first predetermined level 494 and above a second predetermined level 493, the slope of the combined darkness and brightness model will be about 1, providing a linear region 477 for mapping of input to output darkness. For an increased perception of brightness, the model of the invention converges (and compands) the comparatively lower darkness values nonlinearly toward the maximum brightness value 480, illustrated as nonlinear region 478, for both black and CMY values. Similarly, for an increased perception of darkness, the model of the invention converges (and compands) the comparatively greater darkness values nonlinearly toward the maximum black darkness value 485, illustrated as nonlinear region 479, for black, and increases color (CMY) combinations approximately linearly to the maximum color darkness value 490, illustrated as linear region 491 (dotted line). (The addition of small amounts of color are discussed in greater detail below with reference to FIG. 11, and is referred to as approximately linear, as the black and neutral model includes a comparatively small oscillation or dithering of the CMY or other colorant values). Using this combined darkness and brightness model, images are actually perceived to be lighter and to be darker than they really are, as determined by measured luminosity.

More specifically, an output darkness level may be determined for a plurality of colorant values for reproduction of an image on an output medium having a minimum darkness (480), with the reproduction having a maximum black colorant darkness (485) on the output medium. When an input darkness of a selected pixel of the plurality of pixels is greater than a first predetermined darkness level (494), the output black darkness of the selected pixel is constrained to a value less than or equal to the lesser of the input darkness (illustrated by line 460) and the maximum darkness (485), illustrated as region 479. Similarly, when the input darkness of the selected pixel is less than a second predetermined level (493), the output black darkness of the selected pixel is constrained to a value greater than or equal to the greater of the input darkness and the minimum darkness (480), illustrated as region 478. As illustrated, the constraining of the output black darkness is substantially nonlinear, and is typically the “s” portion of a sigmoidal shaped curve or mapping. When the input darkness of the selected pixel is not greater than the first predetermined darkness level (494) and is not less than the second predetermined darkness level (493), the output black darkness of the selected pixel is determined as a substantially linear mapping from the input darkness, illustrated as region 477.

As mentioned above, this nonlinear combined darkness and lightness model is one of the truly unique features of the present invention, and is applied to each hue of the ATD color space, providing the capability to darken and brighten each individual pixel of a selected image. In addition, as illustrated, the nonlinear compander (illustrated as line 450) also compensates for the darkness of the substrate, allowing images to appear to be lighter than the surrounding medium. As a consequence, in exemplary embodiments, the combined darkness and brightness model is then adapted for selected substrate (e.g., paper) and ink combinations, for example, when utilized to drive a printer as an output device.

As an example, continuing to refer to FIG. 10, the comparatively greater darkness level of D₁, which would ideally map to a darkness level (484) if a complete range of darkness values were available (on line 460), is instead mapped to a darkness level (487, from line 450) which is less than the maximum available darkness level (of 485), even though the maximum available darkness is closer to the ideal darkness level. Similarly, also as an example, the comparatively lesser darkness level of D₂, which would ideally map to a darkness level (488) if a complete range of darkness or brightness values were available (on line 460), is instead mapped to a darkness level (489, from line 450) which is actually darker than the minimum available darkness level (of 480), even though the minimum available darkness is closer to the ideal darkness level.

The black and neutral models of the present invention are also unique. In accordance with the present invention, it is no longer necessary to utilize a large amount of cyan, magenta and yellow ink to produce neutral colors in an image or to darken the image. Rather, the black and neutral models primarily utilize black to generate blacks, grays and other neutrals, and utilize small amounts (generally about 7% or less, except for very dark grays and blacks) of CMY or other colorants in various combinations to generate fine gradations (and interpolations) between the levels obtainable by using degrees of black. Also illustrated above, the combined darkness and brightness model is utilized to provide the darkening or lightening of the color in each pixel of the image.

In addition, black tones also utilize very little of the colored inks. Small amounts of colored inks such as CMY are used instead to create a much finer long range gray scale than is possible with traditional separation methods. This use of small amounts of the colored inks removes the problems of image interaction and light source dependence (metamerism). This small use of colored ink also removes the need for careful color balance and eliminates the long runs of wasteful testing runs. The change of the paradigm in producing neutral colors leads to a great savings in paper and ink. As mentioned above, the combined darkness and lightness model takes into account the requirement for using small amounts of cyan, magenta and yellow inks to produce the fine neutral scale.

FIG. 11 is graphical diagram illustrating an exemplary output (as colorant (ink) percentages) for black (combined brightness and darkness) and neutral models in accordance with the teachings of the present invention. As illustrated, the vast majority of darkening utilizes a black ink, as illustrated on line 500, and is nonlinear to the extent discussed above for the darkness/brightness model. As mentioned, black is utilized primarily to create the grays and neutral tones, with comparatively small amounts of cyan, magenta or yellow utilized to create finer gradations in the gray/neutral scale, essentially creating interpolations between the gray and black levels obtained through the use of black alone. Line 505 graphically 10 illustrates the amounts of colorants (e.g., cyan, magenta, yellow or other primary or secondary colorants) which are then included in selected combinations with the black ink, to produce the final darkened image. As illustrated, to provide both darkening and neutral tones, small amounts of CMY (or other colorants) are utilized, increasing linearly to a first predetermined level of approximately 6 or 7% (linear dot output), to provide neutral tones and darkening. With increasing input darkness, the CMY output is maintained in the vicinity of 6 or 7%, with significantly increasing amounts of black. The amounts of CMY are “dithered” or oscillated slightly around this 6-7% range, providing additional gradations of neutral tones (and a gray scale with 1020 levels). To provide neutral tones having darkness levels of 10% and higher, CMY amounts are only quadratically (approximately, with some oscillation/dithering) increased above this first level, with the maximum level of CMY selected depending upon the maximum level of colorant usage (output) which may be selected, and may range from approximately 40% to 100% utilized for 100% darkness. In addition, the amount of colorants utilized, such as CMY, will vary based on the selected color model; for example, blackness may be achieved utilizing only a black pigment without other colorants, or may utilize one or more of the various colorants (such as CMY).

FIG. 12 is diagram illustrating an exemplary neutral model in accordance with the teachings of the present invention. As illustrated in FIG. 12, the vertical axis defines increasing levels (percentages) of black colorant (ink), while the horizontal axis defines changing CMY values, where each CMY combination maintains gray balance. This results in the exemplary 1020 levels of gray, which are substantially spectrally flat, using all combinations of K and CMY steps in small step increments. In exemplary embodiments, FIG. 12 may be utilized as a target for neutral calibration of the selected output device, following gray (neutral) balancing of the selected output device (i.e., gray balancing to determine the comparative amounts of CMY to provide selected gray, neutral increments).

This neutral and black model of the present invention is in sharp contrast with the prior art, in which neutral and black utilize CMY levels in the ratios of 100:80:80, respectively, at all levels of darkness, which contributes substantially to strong metameric effects (as the prior art neutrals are not substantially spectrally flat). In addition, in accordance with exemplary embodiments, where possible, only 2 of the 3 CMY are utilized for or in the chromatic portion of the image before the addition of a darkness component, to further decrease metameric effects. In addition, this use of small amounts of CMY reduces the need for gray and neutral balancing in commercial printing and graphic arts applications.

FIG. 13 is graphical diagram illustrating an exemplary chroma reduction for a darkness model in accordance with the teachings of the present invention, and provides a graphical illustration and a partial summary of the discussion above. As previously mentioned, with increasing darkness, additional black is utilized. To maintain saturation and hue, albeit darkened, chroma is substantially maintained while darkened. As illustrated for chroma 1 (line 510), chroma 2 (line 515) and maximum chroma (line 520) in FIG. 13, chroma is not reduced significantly until approximately 80% to 90% darkness is required. In addition, even for maximum chroma, substantial chroma is maintained until darkness levels approach approximately 95%. This maintenance of chroma solves the problem of a loss of colorfulness in images typically found in systems utilizing gray component replacement (GCR) or other color removal (UCR).

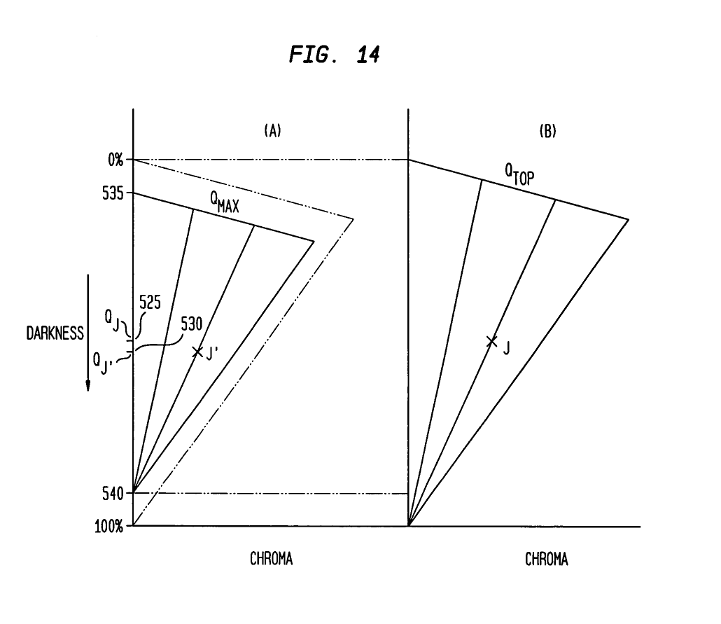

As mentioned above, there may be instances where the selected output device does not provide for the full gamut or range of hues, brightness and darkness levels available in the ATD or other color gamuts. As a consequence, in accordance with the present invention, the same proportions of hue, brightness and darkness are generally maintained (except in the nonlinear brightness and darkness regions discussed above). More specifically, the same ratios with respect to the brightest available hues (Q_{TOP}) are maintained in an out-of-gamut mapping. FIG. 14 is diagram illustrating exemplary proportional out-of-gamut companding in accordance with the teachings of the present invention. The right (B) side of FIG. 14 illustrates the brightness gamut for a selected hue in the full ATD color space, while the left (A) side illustrates a more constrained gamut for the selected hue, having a lower brightness 535 (Q_{MAX}) and less darkness 540 available. As illustrated in FIG. 14, rather than preserving a particular luminance or brightness level, a selected hue 10 having a particular brightness level (Qj) 525, illustrated as “J” in the right (B) side of FIG. 14, is ratiometrically mapped to “J” having a particular brightness level (Qⱼ′) 530 in the left (A) side of FIG. 14. In this gamut mapping, the same chroma is maintained, and the brightness ratios between the gamuts are maintained, such that Q_{J}/Q_{TOP}32 Q_{J′}/Q_{MAX}. This is in sharp contrast with the prior art, in which the same luminance values would be maintained but chroma would be reduced, such as in Granger U.S. Pat. No. 5,650,942, issued Jul. 22, 1997.

As previously discussed with reference to FIG. 8, a selected output device is calibrated, to determine its chromaticity gain limits, and in exemplary embodiments, to linearize chromaticity increments as a function of applied colorants (such as linear dot percentages). In addition, the brightest hues available for the selected output device are also determined and measured, to determine Q_{MAX} for each available hue. In exemplary embodiments, a hex chart 600 such at that illustrated in FIG. 15 is utilized for this brightness calibration, at maximum available brightness levels, with increasing chroma (saturation) toward the periphery 640, as illustrated using successively larger (heavier) dots. As illustrated, the hex chart includes available hues as CMY combinations at various saturation levels, with the brightest available white 645 at the center, with three axes representing cyan (605), magenta (610) and yellow (615), and 3 axes representing the red (620), green (625) and blue (630) overprint combinations. Measurements are performed in equal chromaticity increments, with linear interpolation between measurements. The resulting measurements and interpolated values are utilized to populate the various tables for the selected output device, resulting in a plurality of ATD, XYZ or RGB hue and saturation values which are calibrated for the output device. As indicated above, any such XYZ or RGB values may be readily converted into ATD or Qtd values, as may be necessary or desirable. Once calibrated, ATD or Qtd values may be utilized as an index into the calibrated table, which then provides output values of the CMYK values needed to drive the output device (and result in the selected ATD or Qtd values of the reproduced image). The Q_{MAX} values are then available for comparison with Q_{TOP} of the models and utilization in the various ratiometric determinations.

As mentioned above, input tristimulus values, such as RGB, CIE XYZ, ATD, or Qtd, in the exemplary embodiment, are utilized as indices to database lookup tables, which are configured or populated in advance with output data which has been calibrated for the selected output device and which have been modified in advance by the various models of the present invention. As a consequence, a set of tristimulus values for a selected pixel provides an index (or CAM, for content addressable memory) for one or more database tables. The output from the tables are a plurality of colorant values (such as exemplary CMYK values) for the pixel. In exemplary embodiments, the output values for the pixel have the following form, illustrated with respect to an exemplary CMYK system:
C_{OUT}=α_{C}(H,S)+C_{DARK}(Q/Q_{TOP});
M_{OUT}=α_{M}(H,S)+M_{DARK}(Q/Q_{TOP});
Y_{OUT}=α_{Y}(H,S)+Y_{DARK}(Q/Q_{TOP}); and
K_{OUT}=K_{DARK}.
For example, the output cyan (or magenta or yellow, respectively) is specified by the cyan (or magenta or yellow) levels from a hue and saturation index, as attenuated by any “α” (FIG. 9), and as adjusted by the darkness/brightness model. The output black is provided by the darkness/brightness model, as illustrated in FIG. 10.

The various color management models of the present invention, such as the chromaticity gain model, the darkness and brightness model, and the neutral model, may be embodied in any of a plurality of forms, such as in software and database tables (e.g., relational database tables), as discussed above. FIG. 16 is a flow chart for determining colorant values for the color management methodology in accordance with the teachings of the present invention, and may be embodied as software, for example, and provides a useful summary of the inventive features of the exemplary embodiments.

Referring to FIG. 16, a computer-implemented method of determining colorant values for reproduction of an image begins, start step 700, with providing or determining a first plurality of tristimulus values for a selected pixel of the image, step 705. The plurality of tristimulus values are generally at least one of the following types of tristimulus values, such as CIE XYZ, CIELAB, RGB, ATD, or Qtd. The plurality of tristimulus values may be determined as an input of a corresponding plurality of digital values from a scanned image, from a digital photograph, or from a digital graphics image. In addition, the plurality of tristimulus values may be converted, for example, from RGB or XYZ to ATD or Qtd. Next, in step 710, a corresponding hue is determined for the selected pixel, which may be specified, for example, utilizing t or d chromaticity coordinates. In step 715, a corresponding saturation for the selected pixel is determined, and is constrained to be below a corresponding chromaticity gain limit.

The step of constraining the saturation below the corresponding chromaticity gain limit is based upon determining the corresponding chromaticity gain limit as a maximum perceived chromaticity as a function of increasing colorant saturation, as discussed above with reference to FIGS. 5-7. Also as discussed above, the determination of the hue and saturation may be accomplished through a lookup table maintained in database 70 and indexed through the tristimulus values, such as the t or d chromaticity coordinates. In exemplary embodiments, the constraining or companding of the saturation (or chroma) to the chromaticity gain limit may be accomplished through the corresponding constraining of the saturation values input into and contained in the lookup table.

Next, a corresponding darkness is determined for the selected pixel, utilizing the darkness and brightness model of the invention. The method may include determining a maximum black darkness and determining a minimum darkness, such as the darkness/brightness of the substrate, and correspondingly constraining a black darkness of the selected pixel as illustrated in FIG. 10.

More particularly, in step 720, the method determines whether the input darkness is greater than a first predetermined darkness level (494). When an input darkness of the selected pixel is greater than the first predetermined darkness level in step 720, then in step 725, an output black darkness of the selected pixel is constrained to a value less than or equal to the lesser of the input darkness and the maximum darkness, generally nonlinearly as illustrated for region 479 in FIG. 10. When an input darkness of the selected pixel is not greater than the first predetermined darkness level in step 720, then in step 730, the method determines whether the input darkness is less than a second predetermined darkness level (493). When the input darkness of the selected pixel is less than a second predetermined darkness level in step 730, the output black darkness of the selected pixel is constrained to a value greater than or equal to the greater of the input darkness and the minimum darkness, step 735, generally nonlinearly as illustrated for region 478 in FIG. 10. When the input darkness of the selected pixel is not greater than the first predetermined darkness level in step 720 and is not less than the second predetermined darkness level in step 730, the output black darkness of the selected pixel is determined as substantially equal to the input darkness, step 740, generally linearly mapped as illustrated for region 477 in FIG. 10.

Following steps 725, 735 or 740, the method applies the neutral model of the invention, step 745, selecting primary or secondary colorants constrained at or below a first predetermined colorant level (e.g., 6-7% or 5-8%) for a first corresponding darkness level (e.g., 80%) and at or below a second predetermined colorant level (e.g., 40-100%) for a second corresponding darkness level (e.g., 80-100%). For example, the determination of the darkness for the selected pixel may further comprise selecting a darkness level provided as a black colorant having a saturation between about zero and one hundred percent and with a primary colorant providing less than a first predetermined level of saturation, such as about ten percent saturation, or alternatively, with a primary colorant providing less than about seven percent saturation. For greater darkness levels, the determination of the darkness for the selected pixel may further comprise selecting a darkness level provided as a black colorant having a saturation between about eighty and one hundred percent and with a primary colorant providing less than a second predetermined level of saturation, such as a second level between about forty to one hundred percent saturation. In addition, in selected embodiments, a darkness level may be provided as a black colorant and not more than two primary colorants.

Next, in step 750, a corresponding plurality of primary and black colorant values are determined for the determined hue, saturation and darkness of the selected pixel, and may be provided as output to a selected output device. This step of determining the corresponding plurality of primary and black colorant values may further include substantially maintaining a chroma for the determined hue until the determined darkness is greater than about eighty percent. In addition, the step of determining the corresponding plurality of primary and black colorant values may include performing at least one database table lookup, with the database table containing a corresponding plurality of primary and black colorant values calibrated for a selected output device.

Following step 750, the method determines whether there are remaining pixels of the plurality of pixels, step 755; if so, the method returns to step 705. When there are no additional pixels requiring determination of colorant values in step 755, the method may end, return step 760.

The combined darkness and brightness model of the present invention may also be summarized as a computer-implemented method of determining an output darkness level for a plurality of colorant values for reproduction of an image on an output medium, where the output medium has a maximum black colorant darkness and a minimum media darkness, with the image having a plurality of pixels. As illustrated in FIG. 10, the method comprises constraining a black darkness of the selected pixel to a value less than or equal to the maximum black darkness when the darkness of a selected pixel of the plurality of pixels is greater than the maximum black colorant darkness; and when the darkness of the selected pixel is less than the minimum media darkness, constraining the black darkness of the selected pixel to a value greater than or equal to the minimum media darkness. In addition, when the darkness of a selected pixel of the plurality of pixels is not greater than the maximum black colorant darkness and is not less than the minimum media darkness, the model determines the black darkness of the selected pixel as a substantially linear mapping of an input darkness level.

The neutral model of the present invention may also be summarized as a computer-implemented method of determining a plurality of neutral gray values for reproduction of an image on an output medium, with the output medium having a maximum black colorant darkness. As illustrated in FIGS. 11 and 12, the method includes increasing a black colorant in linear increments to the maximum black colorant darkness to provide a plurality of black increments; maintaining a first plurality of primary colorants substantially at a first colorant level for each black increment of the plurality of black increments, where the first colorant level is typically between about 6 to 7 percent saturation; and combining the first plurality of primary colorants with the plurality of black increments to form a first plurality of neutral gray increment values. In addition, a second plurality of primary colorants is maintained substantially at a second colorant level for each black increment of the plurality of black increments, the second colorant level comparatively lower than the first colorant level, and with the second colorant level between about 5 to 6 percent saturation; and then combining the second plurality of primary colorants with the plurality of black increments to form a second plurality of neutral gray increment values.

A third plurality of primary colorants is maintained substantially at a third colorant level for each black increment of the plurality of black increments, the third colorant level comparatively greater than the first colorant level, for example, the third colorant level is between about 7 to 8 percent saturation; and then combining the third plurality of primary colorants with the plurality of black increments to form a third plurality of neutral gray increment values. In addition, for greater darkness levels, the model includes increasing a fourth plurality of primary colorants in substantially linear increments to a fourth colorant level to provide a plurality of primary colorant increments, the fourth colorant level comparatively greater than the first colorant level and the third colorant level, but typically less than 40-100 percent saturation; and combining the fourth plurality of primary colorants with a subset of the plurality of black increments, the subset of the plurality of black increments having corresponding black colorant levels greater than a predetermined threshold, such as 80%, to form a fourth plurality of neutral increments. Lastly, the neutral model combines the first, second, third and fourth plurality of neutral gray increment values to form the plurality of neutral gray values.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

1. A processor-implemented method of determining colorant values for reproduction of an image, the method comprising:
providing as input a first plurality of tristimulus values for a selected pixel of the image;
determining an output hue for the selected pixel;
determining an output saturation for the selected pixel;
determining an output darkness for the selected pixel, wherein the output darkness is constrained nonlinearly by a minimum darkness of a substrate and a maximum darkness of selected colorants applied to the substrate; and
determining a corresponding plurality of colorant values for the output hue, output saturation and output darkness of the selected pixel.

2. The method of claim 1, wherein the determination of the output saturation for the selected pixel further comprises:
constraining the saturation below a corresponding chromaticity gain limit.

3. The method of claim 2, wherein the step of constraining the saturation below the corresponding chromaticity gain limit further comprises:
determining the corresponding chromaticity gain limit as a maximum perceived chromaticity as a function of increasing colorant saturation.

4. The method of claim 1, wherein the plurality of tristimulus values are at least one of the following types of tristimulus values: CIE XYZ, CIELAB, RGB, ATD, or Qtd.

5. The method of claim 1, wherein the plurality of tristimulus values are determined as an input of a corresponding plurality of digital values from a scanned image, from a digital photograph, or from a digital graphics image.

6. The method of claim 1, wherein the step of determining the output darkness for the selected pixel further comprises:
when an input darkness of the selected pixel is greater than a first predetermined darkness level, constraining an output black darkness of the selected pixel to a value less than or equal to the lesser of the input darkness and the maximum darkness.

7. The method of claim 6, further comprising:
nonlinearly mapping the output black darkness of the selected pixel to the value less than or equal to the lesser of the input darkness and the maximum darkness.

8. The method of claim 6, wherein the step of determining the darkness for the selected pixel further comprises:
when the input darkness of the selected pixel is less than a second predetermined darkness level, constraining an output black darkness of the selected pixel to a value greater than or equal to the greater of the input darkness and the minimum darkness.

9. The method of claim 8, further comprising:
nonlinearly mapping the output black darkness of the selected pixel to a value greater than or equal to the greater of the input darkness and the minimum darkness.

10. The method of claim 8, further comprising:
when the input darkness of the selected pixel is not greater than the first predetermined darkness level and is not less than the second predetermined darkness level, determining the output black darkness of the selected pixel as substantially equal to the input darkness.

11. The method of claim 1, wherein the step of determining the darkness for the selected pixel further comprises:
selecting a darkness level provided as a black colorant having a saturation between about zero and one hundred percent and with a primary colorant providing less than about seven to ten percent saturation.

12. The method of claim 1, wherein the step of determining the darkness for the selected pixel further comprises:
selecting a darkness level provided as a black colorant having a saturation between about zero and one hundred percent and with a primary colorant providing less than about forty to one-hundred percent saturation.

13. The method of claim 1, wherein the step of determining the darkness for the selected pixel further comprises:
selecting a darkness level provided as a black colorant and not more than two primary colorants.

14. The method of claim 1, wherein the step of determining the corresponding plurality colorant values for the determined hue, saturation and darkness of the selected pixel further comprises:
substantially maintaining a chroma for the determined hue and saturation until the determined darkness is greater than about eighty percent.

15. The method of claim 1, wherein the step of providing the first plurality of tristimulus values for a selected pixel of the image further comprises:
converting a plurality of input RGB values to a plurality of ATD values substantially as about
$$[ \begin{matrix}A \\ T \\ D\end{matrix} ] = [ \begin{matrix}0.0 & 4.0 & 0.0 \\ 2.506 & - 2.306 & - 0.0688 \\ 0.4427 & 0.5988 & - 0.9369\end{matrix} ] [ \begin{matrix}X \\ Y \\ Z\end{matrix} ] .$$

16. The method of claim 1, wherein the steps of determining the hue, the saturation and the darkness for the selected pixel further comprises:
performing at least one database table lookup indexed by the plurality of tristimulus values.

17. The method of claim 1, wherein the step of determining the corresponding plurality of colorant values further comprises:
performing at least one database table lookup, the database table containing a corresponding plurality of primary and black colorant values calibrated for a selected output device.

18. The method of claim 1, wherein the plurality of tristimulus values further comprises at least one brightness value which is substantially nonlinear with respect to a luminance value.

19. The method of claim 1, wherein the plurality of tristimulus values further comprises a first value which is substantially a luminance value, a second value which is substantially a red and green opponent value, and a third value which is substantially a blue and yellow opponent value.

20. A computer-implemented method of determining an output darkness level for a plurality of colorant values for reproduction of an image on an output medium having a minimum darkness, the reproduction having a maximum black colorant darkness on the output medium, the image having a plurality of pixels, the method comprising:
when an input darkness of a selected pixel of the plurality of pixels is greater than a first predetermined darkness level, constraining an output black darkness of the selected pixel to a value less than or equal to the lesser of the input darkness and the maximum darkness; and
when the input darkness of the selected pixel is less than a second predetermined level, constraining the output black darkness of the selected pixel to a value greater than or equal to the greater of the input darkness and the minimum darkness.

21. The method of claim 20, further comprising:
when the input darkness of the selected pixel is not greater than the first predetermined darkness level and is not less than the second predetermined darkness level, determining the output black darkness of the selected pixel as a substantially linear mapping from the input darkness.

22. The method of claim 20, further comprising:
substantially maintaining a chroma for the selected pixel until the output black darkness is greater than about eighty percent.

23. The method of claim 20, wherein the constraining of the output black darkness is substantially nonlinear.

24. An apparatus for determining an output darkness level for a plurality of colorant values for reproduction of an image on an output medium having a minimum darkness, the reproduction having a maximum black colorant darkness on the output medium, the image having a plurality of pixels, the apparatus comprising:
a memory; and
a processor coupled to the memory, the processor adapted, when an input darkness level of a selected pixel of the plurality of pixels is greater than a first predetermined darkness level, to nonlinearly constrain an output black darkness of the selected pixel to a value less than or equal to the lesser of the input darkness level and the maximum darkness, and when the input darkness level of the selected pixel is less than a second predetermined level, to nonlinearly constrain the output black darkness of the selected pixel to a value greater than or equal to the greater of the input darkness level and the minimum darkness.

25. The apparatus of claim 24, wherein the processor is further adapted, when the input darkness level of the selected pixel of the plurality of pixels is not greater than the first predetermined darkness level and is not less than the second predetermined level, to determine the output black darkness of the selected pixel as a substantially linear mapping from the input darkness level.

26. The apparatus of claim 24, further comprising at least one output device of a plurality of output devices, the plurality of output devices comprising one or more of the following output devices: an inkjet printer; a laserjet; printer; a printing press; an electronic display; a machine-readable medium.

27. The apparatus of claim 24, wherein the processor is further adapted to substantially maintain a chroma for the selected pixel until the output black darkness is greater than about eighty percent.

28. The apparatus of claim 24, wherein the processor is further adapted, when the selected pixel is out-of-gamut for a selected output device, to map the selected pixel to one or more output values having substantially the same chroma and same proportional brightness of the selected pixel.

29. The apparatus of claim 24, wherein the processor is further adapted to constrain an output saturation of the selected pixel below a corresponding chromaticity gain limit.

30. The apparatus of claim 24, wherein the processor is further adapted to provide an output neutral tone as a substantially linearly increasing black colorant up to about eighty percent saturation coupled with a primary colorant constrained to less than about ten percent saturation.

31. The apparatus of claim 24, wherein the processor is further adapted to provide an output neutral tone as a black colorant having 80-100 percent saturation coupled with a primary colorant constrained to less than about eighty percent saturation.

32. The apparatus of claim 24, wherein the image may be provided as a plurality of tristimulus values which are independent of any selected output device.

33. The apparatus of claim 24, wherein the memory is adapted to store a database table, and wherein the processor is further adapted to determine a hue, a saturation and the darkness for the selected pixel by performing at least one database table lookup indexed by a plurality of tristimulus values.

34. The apparatus of claim 33, wherein the database table is adapted to store a corresponding plurality of primary and black colorant values calibrated for a selected output device.

35. The apparatus of claim 33, wherein the plurality of tristimulus values further comprises at least one brightness value which is substantially nonlinear with respect to a luminance value.

36. The apparatus of claim 33, wherein the plurality of tristimulus values further comprises a first value which is substantially a luminance value, a second value which is substantially a red and green opponent value, and a third value which is substantially a blue and yellow opponent value.

37. The apparatus of claim 33, further comprising:
an input/output interface adapted to receive as input the plurality of tristimulus values representing the image, wherein plurality of tristimulus values are independent of any selected output device.

38. The apparatus of claim 33, wherein the plurality of tristimulus values encompass substantially all visually perceptible colors.

39. A machine-readable medium storing instructions for determining an output darkness level for a plurality of colorant values for reproduction of an image on an output medium having a minimum darkness, the reproduction having a maximum black colorant darkness on the output medium, the image having a plurality of pixels, the machine-readable medium comprising:
a first program construct to nonlinearly constrain an output black darkness of the selected pixel to a value less than or equal to the lesser of the input darkness level and the maximum darkness when an input darkness level of a selected pixel of the plurality of pixels is greater than a first predetermined darkness level; and
a second program construct to nonlinearly constrain the output black darkness of the selected pixel to a value greater than or equal to the greater of the input darkness level and the minimum darkness when the input darkness level of the selected pixel is less than a second predetermined level.

40. The machine-readable medium of claim 39, further comprising:
a third program construct to determine the output black darkness of the selected pixel as a substantially linear mapping from the input darkness level when the input darkness level of the selected pixel of the plurality of pixels is not greater than the first predetermined darkness level and is not less than the second predetermined level.

41. The machine-readable medium of claim 39, further comprising:
a fourth program construct to substantially maintain a chroma for the selected pixel until the output black darkness is greater than about eighty percent.

42. The machine-readable medium of claim 39, further comprising:
a fifth program construct to map the selected pixel to one or more output values having substantially the same chroma and same proportional brightness of the selected pixel when the selected pixel is out-of-gamut for a selected output device.

43. The machine-readable medium of claim 39, further comprising:
a sixth program construct to constrain an output saturation of the selected pixel below a corresponding chromaticity gain limit.

44. The machine-readable medium of claim 39, further comprising:
a seventh program construct to provide an output neutral tone as a substantially linearly increasing black colorant up to about eighty percent saturation coupled with a primary colorant constrained to less than about ten percent saturation.

45. The machine-readable medium of claim 39, further comprising:
an eighth program construct to determine a hue, a saturation and the darkness for the selected pixel by performing at least one database table lookup indexed by a plurality of tristimulus values.
